(19) United States
(12) Patent Application Publication
(10) Pub. No.: US 2026/0059250 A1
(43) Pub. Date: Feb. 26, 2026

(54) Headset Fitness Detection Method and Headset

(71) Applicant: Honor Device Co., Ltd., Shenzhen (CN)

(72) Inventor: Rongzhi Yang, Shenzhen (CN)

(21) Appl. No.: 19/104,983

(22) PCT Filed: Sep. 6, 2023
(86) PCT No.: PCT/CN2023/117305

§ 371 Date: Feb. 19, 2025

(30) Foreign Application Priority Data
Dec. 9, 2022 (CN) 202211580027.3

(51) Int. Cl. H04R 29/00; H04R 1/10

(52) U.S. Cl. CPC H04R 29/001; H04R 1/1016; H04R 1/1041; H04R 2201/107; H04R 2460/15

(57) ABSTRACT

A headset fitness detection method and a headset, which is enabled to process a mutually exclusive scenario for headset fitness detection, to improve compatibility of a headset fitness detection function. The headset fitness detection method that is applied to a headset includes: starting a first service, where the first service is a service in which a noise reduction parameter of the headset is changed, or a service in which another piece of audio other than audio required for headset fitness detection is played; receiving a fitness detection command from an electronic device, where the fitness detection command is used to indicate the headset to perform the headset fitness detection; determining that the ongoing first service and the headset fitness detection are mutually exclusive; and prohibiting the headset fitness detection.

This application claims priority to Chinese Patent Application No. 202211580027.3, filed with the China National Intellectual Property Administration on Dec. 9, 2022 and entitled “HEADSET FITNESS DETECTION METHOD AND HEADSET”, which is incorporated herein by reference in its entirety.

### TECHNICAL FIELD

This application relates to the field of electronic technologies, and in particular, to a headset fitness detection method and a headset.

### BACKGROUND

An in-ear true wireless stereo (true wireless stereo, TWS) headset may determine, by using a headset fitness detection function, whether an ear canal of a user fits the headset. A basic principle of headset fitness detection is as follows: After a loudspeaker in the headset is partially inserted into the ear canal of the user, the loudspeaker in the headset plays a preset audio segment based on a preset headset fitness detection parameter (for example, a noise reduction parameter): a microphone (located outside the ear canal) in the headset captures ambient sound (including preset audio leaked from a gap between the ear canal and the headset); and the headset determines a leakage value of the preset audio by analyzing the played preset audio and the received leaked preset audio. A smaller leakage value indicates a higher degree of fitness between the ear canal of the user and the headset. In some scenarios, during the headset fitness detection, if the headset plays another sound or changes the noise reduction parameter, accuracy of the headset fitness detection is affected. This scenario is briefly referred to as a mutually exclusive scenario for the headset fitness detection.

In a conventional technology, a headset application on an electronic device side processes this mutually exclusive scenario. However, for some operating systems of the electronic device, permissions of the headset application are limited, and consequently, after a same type of headset is connected to electronic devices using different operating systems, different processing manners are used for a same mutually exclusive scenario during the headset fitness detection, and this causes trouble to the user.

### SUMMARY

Embodiments of this application provide a headset fitness detection method and a headset, so that the headset is enabled to process a mutually exclusive scenario for headset fitness detection, to improve compatibility of a headset fitness detection function.

To achieve the foregoing objective, the following technical solutions are used in embodiments of this application.

According to a first aspect, a headset fitness detection method is provided, and is applied to a headset. The method includes: receiving a service start command from an electronic device, where the service start command is used to indicate the headset to start a first service, where the first service is a service in which a noise reduction parameter of the headset is changed, or a service in which another piece of audio other than audio required for headset fitness detection is played: starting the first service: receiving a fitness detection command from the electronic device, where the fitness detection command is used to indicate the headset to perform the headset fitness detection; and if it is determined that the ongoing first service and the headset fitness detection are mutually exclusive, prohibiting the headset fitness detection.

According to the headset fitness detection method provided in this embodiment of this application, the headset is already performing the first service. In the first service, a service of the noise reduction parameter of the headset may be changed, or another piece of audio other than the audio required for the headset fitness detection may be played, and consequently; accuracy of the headset fitness detection is reduced. In this case, if the headset receives the fitness detection command (the fitness detection command is used to indicate the headset to perform the headset fitness detection), the headset prohibits the headset fitness detection (that is, does not start the headset fitness detection). Therefore, the headset performs control logic to avoid a conflict with the first service by reducing a priority of the headset fitness detection, and does not rely on permissions granted to a headset application by an operating system in the electronic device. For electronic devices using different operating systems, the headset has consistent processing for a mutually exclusive scenario, and therefore compatibility of the headset fitness detection can be improved.

In a possible implementation, the first service includes at least one of the following services: a media playing service, a call service, a long prompt tone playing service, or a voice assistant wake-up service.

Audio is played in the media playing service and the long prompt tone playing service, and in the call service and the voice assistant wake-up service, the noise reduction parameter of the headset is changed to collect voice and reduce noise. Consequently, accuracy of the headset fitness detection is reduced.

In a possible implementation, the first service is a call service or a voice assistant wake-up service, and the determining that the ongoing first service and the headset fitness detection are mutually exclusive includes: determining that a voice transmission channel of the headset is in a connected state.

When the voice transmission channel of the headset is in the connected state, it indicates that the electronic device is transmitting audio data of the call service or the voice assistant wake-up service to the headset through the voice transmission channel of the headset.

In a possible implementation, the voice transmission channel is a synchronous connection oriented (synchronous connection oriented, SCO) channel.

A specific type of the voice transmission channel is not limited in this application, and the voice transmission channel may be another type of channel as a protocol evolves.

In a possible implementation, the first service is a media playing service or a long prompt tone playing service, and the determining that the ongoing first service and the headset fitness detection are mutually exclusive includes: determining that an audio transmission channel of the headset is in a playing state or a paused state.

When the audio transmission channel of the headset is in the playing state or the paused state, it indicates that the electronic device is transmitting audio data of the media playing service or the long prompt tone playing service to the headset through the audio transmission channel of the headset.

In a possible implementation, the audio transmission channel is an advanced audio distribution profile (advanced audio distribution profile, A2DP) channel.

A specific type of the audio transmission channel is not limited in this application, and the audio transmission channel may be another type of channel as a protocol evolves.

In a possible implementation, after it is determined that the ongoing first service and the headset fitness detection are mutually exclusive, the method further includes: sending first error indication information to the electronic device, where the first error indication information is used to indicate the headset to prohibit the headset fitness detection.

Therefore, the electronic device may prompt a user that if the headset fitness detection needs to be performed, the ongoing first service that is mutually exclusive to the headset fitness detection needs to be stopped, to avoid reducing accuracy of the headset fitness detection.

According to a second aspect, a headset fitness detection method is provided, and is applied to a headset. The method includes: receiving a fitness detection command from an electronic device, where the fitness detection command is used to indicate the headset to perform headset fitness detection: if it is determined that a first service that is mutually exclusive to the headset fitness detection is not being performed, starting the headset fitness detection, where the first service is a service in which a noise reduction parameter of the headset is changed, or a service in which another piece of audio other than audio required for the headset fitness detection is played; and before the headset fitness detection is completed, if a service start command is received from the electronic device, interrupting the headset fitness detection, and starting the first service, where the service start command is used to indicate the headset to start the first service.

According to the headset fitness detection method provided in this embodiment of this application, when the headset is already performing the headset fitness detection, if a command indicating the headset to perform the first service that is mutually exclusive to the headset fitness detection is received, the headset interrupts the headset fitness detection. In the first service that is mutually exclusive to the headset fitness detection, the noise reduction parameter of the headset may be changed, or another piece of audio other than the audio required for the headset fitness detection may be played. Consequently; accuracy of the headset fitness detection is reduced. Therefore, the headset performs control logic to avoid a conflict with the first service by reducing a priority of the headset fitness detection, and does not rely on permissions granted to a headset application by an operating system in the electronic device. For electronic devices using different operating systems, the headset has consistent processing for a mutually exclusive scenario, and therefore compatibility of the headset fitness detection can be improved.

In a possible implementation, the first service includes at least one of the following services: a media playing service, a call service, a long prompt tone playing service, or a voice assistant wake-up service.

Audio is played in the media playing service and the long prompt tone playing service, and in the call service and the voice assistant wake-up service, the noise reduction parameter of the headset is changed to collect voice and reduce noise. Consequently, accuracy of the headset fitness detection is reduced.

In a possible implementation, the first service is a call service or a voice assistant wake-up service, and the determining that the first service that is mutually exclusive to the headset fitness detection is not being performed includes: determining that a voice transmission channel of the headset is in a disconnected state, and determining that an audio transmission channel of the headset is in an idle state.

When the voice transmission channel of the headset is in the disconnected state, it indicates that the electronic device is not transmitting audio data of the call service or the voice assistant wake-up service to the headset through the voice transmission channel of the headset. When the audio transmission channel of the headset is in the idle state, it indicates that the electronic device is not transmitting audio data of the media playing service or the long prompt tone playing service to the headset through the audio transmission channel of the headset. Therefore, accuracy of the headset fitness detection is not reduced.

In a possible implementation, the voice transmission channel is an SCO channel. A specific type of the voice transmission channel is not limited in this application, and the voice transmission channel may be another type of channel as a protocol evolves.

In a possible implementation, the audio transmission channel is an A2DP channel. A specific type of the audio transmission channel is not limited in this application, and the audio transmission channel may be another type of channel as a protocol evolves.

In a possible implementation, the first service is a media playing service or a long prompt tone playing service, and the service start command is a status switching command for the audio transmission channel, and is used to indicate the headset to switch the audio transmission channel from the idle state to a playing state or a paused state.

In other words, the electronic device indicates the headset to transmit audio data of the media playing service or the long prompt tone playing service through the audio transmission channel of the headset. Accuracy of the headset fitness detection is reduced.

In a possible implementation, the first service is a call service or a voice assistant wake-up service, and the service start command is a status switching command for the voice transmission channel, and is used to indicate the headset to switch the voice transmission channel from an idle state to a connected state.

In other words, the electronic device indicates the headset to transmit audio data of the call service or the voice assistant wake-up service through the voice transmission channel of the headset. Accuracy of the headset fitness detection is reduced.

In a possible implementation, after the receiving the service start command from the electronic device, the method further includes: sending second error indication information to the electronic device, where the second error indication information is used to indicate the headset to interrupt the headset fitness detection.

Therefore, the electronic device may prompt a user that the headset interrupts the headset fitness detection due to the ongoing first service.

According to a third aspect, a headset is provided, and includes a processor and a memory: The memory stores instructions, and the method according to the first aspect and the second aspect and any implementation thereof is performed when the processor executes the instructions.

According to a fourth aspect, a computer-readable storage medium is provided, and includes instructions. When the instructions are run on a headset, the headset is enabled to perform the method according to the first aspect and the second aspect and any implementation thereof.

According to a fifth aspect, a computer program product including instructions is provided. When the instructions are run on a headset, the headset is enabled to perform the method according to the first aspect and the second aspect and any implementation thereof.

According to a sixth aspect, a chip system is provided. The chip system includes a processor, configured to support a headset in implementing functions involved in the first aspect and the second aspect. In a possible design, the apparatus further includes an interface circuit. The interface circuit may be configured to receive a signal from another apparatus (such as a memory) or transmit a signal to another apparatus (such as a communication interface). The chip system may include a chip, or may include another discrete component.

For technical effects of the third aspect to the sixth aspect, refer to technical effects of the first aspect and the second aspect and any implementation thereof, which are not repeated herein.

### BRIEF DESCRIPTION OF DRAWINGS

FIG. 1 is a schematic diagram of an architecture of a communication system according to an embodiment of this application;

FIG. 2 is a schematic diagram of a structure of a headset according to an embodiment of this application:

FIG. 3 is a schematic flowchart of a headset fitness detection method according to an embodiment of this application:

FIG. 4 is a schematic diagram of a mutually exclusive scenario for headset fitness detection according to an embodiment of this application:

FIG. 5 is a schematic flowchart 1 of a headset fitness detection method according to an embodiment of this application;

FIG. 6 is a schematic flowchart 2 of a headset fitness detection method according to an embodiment of this application;

FIG. 7 is a schematic diagram of a display interface of a music player on an electronic device according to an embodiment of this application:

FIG. 8 is a schematic diagram of a display interface of headset fitness detection on an electronic device according to an embodiment of this application:

FIG. 9 is a schematic diagram 1 of display interfaces of a music player and headset fitness detection on an electronic device according to an embodiment of this application:

FIG. 10 is a schematic flowchart 3 of a headset fitness detection method according to an embodiment of this application:

FIG. 11 is a schematic flowchart 4 of a headset fitness detection method according to an embodiment of this application;

FIG. 12 is a schematic diagram 2 of display interfaces of a music player and headset fitness detection on an electronic device according to an embodiment of this application; and

FIG. 13 is a schematic diagram of a structure of a chip system according to an embodiment of this application.

### DESCRIPTION OF EMBODIMENTS

First, some concepts involved in this application will be described below:

In embodiments of this application, terms such as “first” and “second” are merely used for distinguishing features of the same type, and cannot be understood as an indication of relative importance, a quantity, or a sequence.

The term “example” or “for example” involved in embodiments of this application is used to represent giving an example, an illustration, or a description. Any embodiment or design solution described as an “example” or “for example” in this application should not be explained as being more preferred or having more advantages than other embodiments or design solutions. Exactly; use of the word such as “example” or “for example” is intended to present a related concept in a specific manner.

In embodiments of this application, the term “couple” or “connection” should be understood in a broad sense. For example, the connection may be a physically direct connection, or an indirect connection implemented by an electronic component, such as a connection implemented by a resistor, an inductor, a capacitor, or another electronic component.

First, a communication system including an electronic device and a headset is described in embodiments of this application. The electronic device may transmit audio data (for example, play music) to the headset, or send voice data to or receive voice data from (for example, make or answer a call) the headset. Then, a process of headset fitness detection between the electronic device and the headset in a conventional technology is described. In some scenarios, if the headset is still playing another sound or changes a noise reduction parameter (that is, performs a service that is mutually exclusive to headset fitness detection) during the headset fitness detection, accuracy of the headset fitness detection is affected. Several scenarios that affect the accuracy of the headset fitness detection are specifically described. These scenarios are collectively referred to as a mutually exclusive scenario for the headset fitness detection in this application. Then, a headset fitness detection method provided in embodiments of this application is described. When the headset detects that an ongoing service and headset fitness detection are mutually exclusive, the headset prohibits the headset fitness detection, or when the headset is already performing the headset fitness detection but also needs to perform a service that is mutually exclusive to the headset fitness detection, the headset interrupts the headset fitness detection. Therefore, the mutually exclusive scenario for the headset fitness detection is processed, to improve compatibility of a headset fitness detection function.

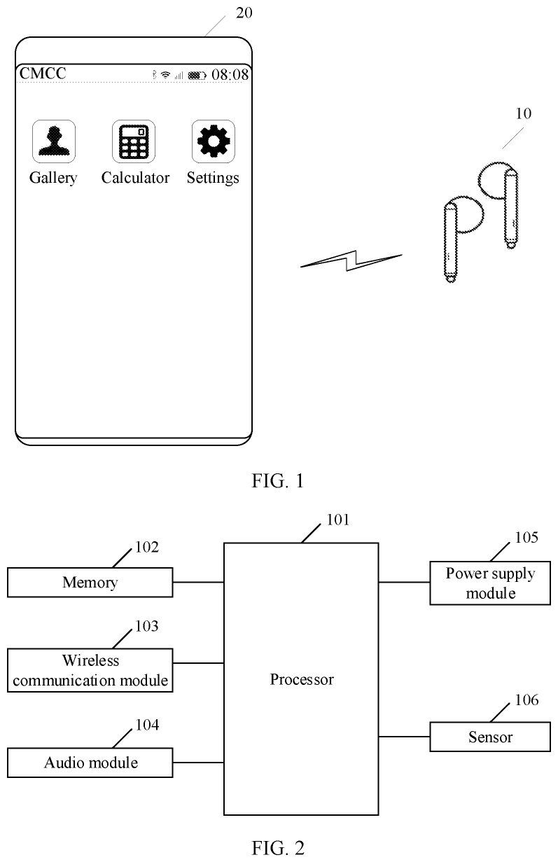

As shown in FIG. 1, an embodiment of this application provides a communication system, including an electronic device 20 and a headset 10. The electronic device 20 may transmit audio data to the headset 10 in a wired communication manner or a wireless communication manner, or send voice data to and receive voice data from the headset 10. The wireless communication manner may be a Bluetooth (bluetooth, BT) communication manner, for example, may be a conventional Bluetooth communication manner or a Bluetooth low energy (for example, Bluetooth low energy (bluetooth low energe, BLE)) communication manner.

The electronic device 20 may be a device such as a mobile phone, a mutlimedia player, a tablet computer, a notebook computer, an augmented reality (augmented reality; AR) device, a virtual reality (virtual reality; VR) device, an ultra-mobile personal computer (ultra-mobile personal computer, UMPC), a personal digital assistant (personal digital assistant, PDA), a television, or a smartwatch. The headset 10 may be a Bluetooth headset, for example, an in-ear TWS headset. There may be a plurality of types of Bluetooth headsets, for example, an earbud-style, in-ear, over-ear, on-ear, or ear-hook Bluetooth headset. Specific forms of the electronic device 20 and the headset 10 are not specially limited in this embodiment of this application.

For example, as shown in FIG. 2, an embodiment of this application provides a headset 10. The headset 10 may be a Bluetooth headset. The headset 10 may include at least one processor 101, at least one memory 102, a wireless communication module 103, an audio module 104, a power supply module 105, a sensor 106, and the like. The processor 101 may include one or more interfaces for connecting to another component of the headset 10. Components of the headset 10 are specifically described below with reference to FIG. 2.

The memory 102 may be configured to store computer program instructions, and the instructions may be used to perform the headset fitness detection method involved in this application. The memory may be a volatile memory or a non-volatile memory; or may include both a volatile memory and a non-volatile memory: The non-volatile memory may be a read-only memory (read-only memory; ROM), a programmable read-only memory (programmable ROM, PROM), an erasable programmable read-only memory (erasable PROM, EPROM), an electrically erasable programmable read-only memory (electrically EPROM, EEPROM), or a flash memory: The volatile memory may be a random access memory (random access memory; RAM), and serves as an external cache. Through example descriptions but not limitative descriptions, many forms of RAMs are available, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM. SLDRAM), and a direct rambus random access memory (direct rambus RAM, DR RAM). It should be noted that the memories used for the system and the method described in this specification are intended to include, but are not limited to, these and any other proper types of memories.

The processor 101 may include one or more processing units, and different processing units may be separate components or may be integrated into one or more processors 101. The processor 101 may be specifically an integrated control chip. The processor 101 may be configured to execute the foregoing instructions, and invoke a related module to perform the headset fitness detection method involved in this embodiment of this application. The processor may be a chip. For example, the processor may be a field programmable gate array (field programmable gate array, FPGA), an application specific integrated circuit (application specific integrated circuit, ASIC), a system on chip (system on chip, SoC), a central processor unit (central processor unit, CPU), a network processor (network processor, NP), a digital signal processor (digital signal processor. DSP), a micro controller unit (micro controller unit, MCU), a programmable logic device (programmable logic device, PLD), or another integrated chip.

The wireless communication module 103 may be configured to support implementation of data transmission between the headset 10 and the electronic device by using a wireless communication technology (for example, the Bluetooth communication technology described above). For example, the wireless communication module 103 may include a Bluetooth chip. The headset 10 may pair with and establish a wireless connection to a Bluetooth chip of the electronic device by using the Bluetooth chip, to implement wireless communication between the headset 10) and the electronic device through the wireless connection. Generally: the Bluetooth chip may support basic rate (basic rate. BR) Bluetooth, enhanced data rate (enhanced data rate. EDR) Bluetooth, BLE, and the like. In addition, the wireless communication module 103 may further include an antenna. The wireless communication module 103 receives an electromagnetic wave through the antenna, performs frequency modulation and filtering processing on an electromagnetic wave signal, and sends a processed signal to the processor 101. The wireless communication module 103 may further receive a to-be-sent signal from the processor 101, perform frequency modulation and amplification on the signal, and convert the signal into an electromagnetic wave for radiation through the antenna.

The audio module 104 may be configured to manage audio data, to enable the headset to input and output an audio stream. For example, the audio module 104 may obtain an audio stream from the wireless communication module 103, or transfer an audio stream to the wireless communication module 103, to implement functions such as answering or making a call, playing music, waking up/turning off a voice assistant of an electronic device connected to the headset 10, and receiving or sending voice data of a user through the Bluetooth headset. The audio module 104 may include a loudspeaker (or referred to as an earpiece or a telephone receiver) assembly for outputting an audio stream, a microphone (or referred to as a voice tube or a mike), a microphone sound-receiving circuit matched with the microphone, and the like. The loudspeaker may be configured to convert an audio-electrical signal into a sound signal and play the sound signal. The microphone may be configured to convert a sound signal into an audio-electrical signal.

The components shown in FIG. 2 may be implemented by hardware that includes one or more signal process or application-specific integrated circuits, software, or a combination of hardware and software. For example, when the Bluetooth headset is a TWS headset, the headset 10 may include a headset body (also referred to as a left headset) worn on a left ear and a headset body (also referred to as a right headset) worn on a right ear. The headset body may include a housing and an internal component. The internal component is disposed in a cavity formed by the housing. The internal component may include a component in the foregoing modules such as the audio module, the power supply module, and the wireless communication module.

When the Bluetooth headset is a TWS headset, the user can use the TWS headset in a dual-ear mode or a single-ear mode. In the single-ear mode, the user wears the left headset or the right headset to perform an audio service such as listening to music or making or answering a call. In the dual-ear mode, the user may wear two headsets to appreciate music or perform another audio service. In the dual-ear mode, the two headsets are classified into a primary headset and a secondary headset. In addition, in a process of using the TWS headset, primary and secondary roles of the two headsets may be further switched based on different conditions. For example, a headset with higher power may be switched to the primary headset, and a headset with lower power may be switched to the secondary headset.

The power supply module 105 may be configured to provide a system power source for the headset 10, supply power to the modules of the headset 10, support the headset 10 in receiving a charging input, and the like. The power supply module 105 may include a power management unit (power management unit, PMU) and a battery. The power management unit may receive an external charging input, transform a voltage of an electrical signal input by a charging circuit, and then provide the electrical signal to a battery for charging, and may further transform a voltage of an electrical signal provided by the battery and then provide the electrical signal for another module such as the audio module 104 or the wireless communication module 103, and prevent battery overcharging, over-discharging, a short circuit, overcurrent, and the like. In some embodiments, the power supply module 105 may further include a wireless charging coil for charging the headset 10 in a wireless manner. In addition, the power management unit may be further configured to monitor parameters such as a battery capacity; a battery cycle count, and a battery health state (leakage or impedance).

The sensor 106 may include a distance sensor or an optical proximity sensor, and may be configured to determine whether the headset 10 is worn by the user. For example, the headset 10 may detect, by using the distance sensor, whether there is an object near the headset 10, to determine whether the headset 10 is worn by the user. When it is determined that the headset 10 is worn, the headset 10 may turn on the loudspeaker.

For another example, the sensor 106 may further include a bone conduction sensor. By using the bone conduction sensor, the headset 10 may obtain a vibration signal from a vibration bone of a vocal-cord part of a human, parse out a voice signal, and implement a voice function, to receive a voice instruction of the user. The headset 10 may further perform voice authentication based on a user voice signal obtained by a bone conduction headset, to authenticate an identity of the user in a service scenario such as payment transaction.

For another example, the sensor 106 may further include: a touch sensor, configured to detect a touch operation of the user: a fingerprint sensor, configured to detect a fingerprint of the user and identify an identity of the user: an ambient light sensor, configured to adaptively adjust some parameters (for example, volume) based on brightness of sensed ambient light; and another possible sensor.

In some embodiments, the touch sensor may detect a touch operation such as tap, double tap, tap for a plurality of times, long press, and heavy press of the user, and may further perform user fingerprint identification, to authenticate the identity of the user in the service scenario such as payment transaction.

It may be understood that, components shown in FIG. 2 do not constitute a specific limitation on the headset 10. The headset 10 may further include more or fewer components than those shown in the figure, or some components may be combined, or some components may be separated, or a different component deployment may be used.

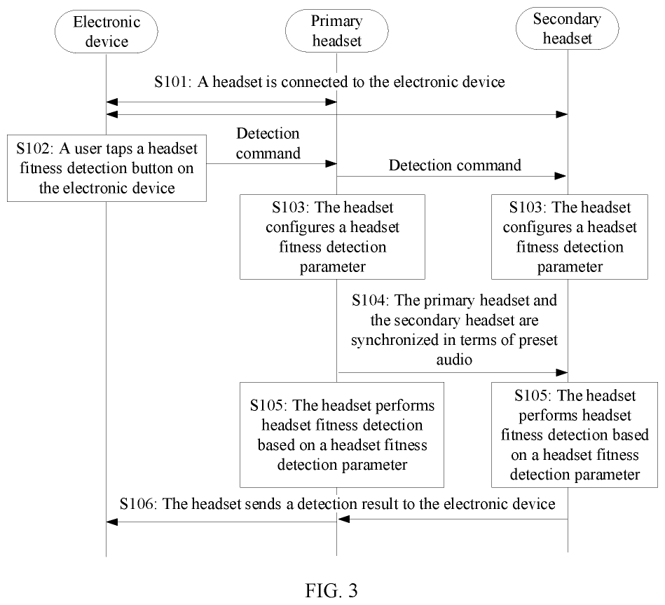

As shown in FIG. 3, a process of headset fitness detection in a conventional technology is as follows:

S101: A headset is connected to an electronic device.

In addition, a user wears the headset. The user may use the headset in a dual-ear mode or a single-ear mode. In the single-ear mode, the user wears a left headset or a right headset to perform an audio service such as listening to music or making or answering a call. In the dual-ear mode, the user may wear two headsets to appreciate music or perform another audio service. In the dual-ear mode, the two headsets are classified into a primary headset and a secondary headset.

S102: The user taps a headset fitness detection button on the electronic device.

In this period, the user cannot remove the headset. After the user taps the headset fitness detection button on the electronic device, the electronic device sends a fitness detection command to the headset, to indicate the headset to perform headset fitness detection. In the dual-ear mode, the electronic device sends the fitness detection command to the primary headset, and the primary headset forwards the fitness detection command to the secondary headset.

S103: The headset configures a headset fitness detection parameter.

For example, the headset fitness detection parameter includes a noise reduction parameter and the like. In the dual-ear mode, the primary headset and the secondary headset respectively configure respective headset fitness detection parameters.

S104: After configuring the headset fitness detection parameters, the primary headset and the secondary headset are synchronized in terms of preset audio.

S105: The headset performs headset fitness detection based on the headset fitness detection parameter (for example, the noise reduction parameter).

In the dual-ear mode, the primary headset and the secondary headset separately perform the headset fitness detection based on the headset fitness detection parameters.

A basic principle of the headset fitness detection is as follows: After a loudspeaker in the headset is partially inserted into an ear canal of the user, the loudspeaker in the headset plays a preset audio segment based on a preset noise reduction parameter: a microphone (located outside the ear canal) in the headset captures ambient sound (including preset audio leaked from a gap between the ear canal and the headset); and the headset determines a leakage value of the preset audio by analyzing the played preset audio and the received leaked preset audio. A smaller leakage value indicates a higher degree of fitness between the ear canal of the user and the headset.

S106: The headset sends a detection result to the electronic device.

In the dual-ear mode, the secondary headset sends a detection result of the secondary headset to the electronic device through forwarding by the primary headset.

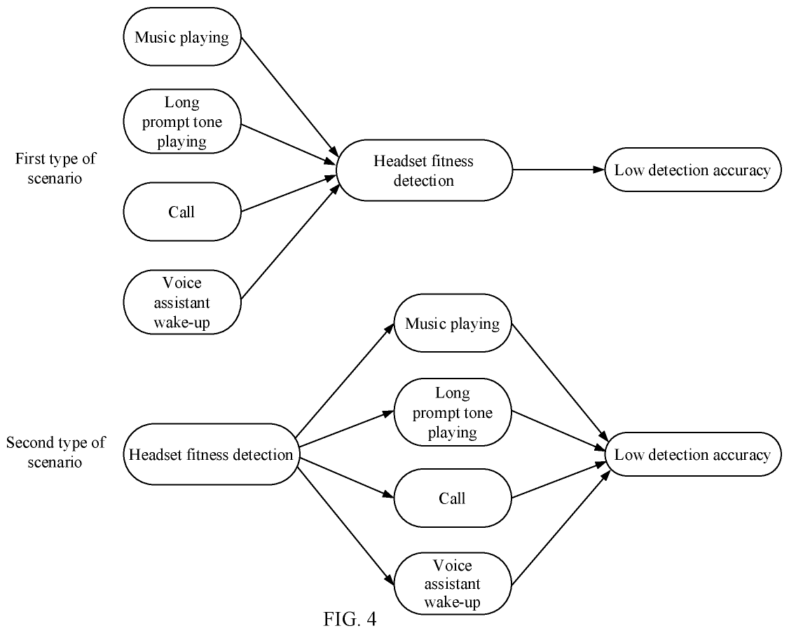

Therefore, during the headset fitness detection, accuracy of the headset fitness detection is affected if the headset plays another sound or changes the noise reduction parameter. A mutually exclusive scenario for the headset fitness detection is described below with reference to FIG. 4.

As shown in FIG. 4, in a first type of scenario, it is assumed that the headset is performing one of the following services (which are referred to as services that are mutually exclusive to the headset fitness detection for short): playing music (that is, is performing a media playing service), playing a long prompt tone (that is, is performing a long prompt tone playing service), making or answering a call (that is, is performing a call service), waking up a voice assistant (that is, is performing a voice assistant wake-up service), and the like. In this case, if the headset enables a headset fitness detection function, because audio is played in the media playing service, the long prompt tone playing service, and the like, and in the call service and the voice assistant wake-up service, the noise reduction parameter of the headset is changed to collect voice and reduce noise. Consequently, accuracy of the headset fitness detection is reduced.

As shown in FIG. 4, in a second type of scenario, it is assumed that the headset is performing the headset fitness detection, and if the headset starts one of the following services (which are referred to as services that are mutually exclusive to the headset fitness detection for short) in this case: playing music (that is, is performing a media playing service), playing a long prompt tone (that is, is performing a long prompt tone playing service), making or answering a call (that is, is performing a call service), waking up a voice assistant (that is, is performing a voice assistant wake-up service), and the like. Audio is played in the media playing service and the long prompt tone playing service, and in the call service and the voice assistant wake-up service, the noise reduction parameter of the headset is changed to collect voice and reduce noise. Consequently, accuracy of the headset fitness detection is reduced.

It should be noted that playing a long prompt tone involved in this application includes but is not limited to playing an incoming call prompt tone, playing an outgoing call prompt tone, playing text to speech (text to speech. TTS) audio (for example. TTS audio broadcasting body temperature), playing self-defined audio, and the like.

To resolve the foregoing problem, a processing manner is as follows: When a service that is mutually exclusive to the headset fitness detection is performed, a headset application (application, APP) on an electronic device (for example, a mobile phone) makes a decision. For example, when a music application on the electronic device controls a headset to play music, a user operates the headset application to perform headset fitness detection, and in this case, the headset application controls the music application to pause music playing, lower music volume, or adjust music volume to mute, and the headset application transmits audio used for the headset fitness detection to the headset. After the headset completes the headset fitness detection, the headset application controls the music application to resume music playing or restore the music volume to original volume.

The foregoing processing manner has the following disadvantages:

On one hand, for some operating systems of the electronic device, extensive permissions are granted to the headset application, and the music application may be controlled in the foregoing manner to process the foregoing mutually exclusive scenario, but for some other operating systems, limited permissions are granted to the headset application, the headset application is not supported in controlling the music application, and the foregoing mutually exclusive scenario cannot be processed. Consequently, after a same headset is connected to electronic devices using different operating systems, different processing manners are used for a same mutually exclusive scenario, and this causes trouble to the user.

On the other hand, as for lowering the music volume, although the music volume is lowered, interference is still caused to audio required for the headset fitness detection, and therefore, there may be a problem of an inaccurate detection result, and a problem of mixed sound caused when music audio and preset audio for the headset fitness detection are simultaneously played may occur. If music playing is paused or the music volume is adjusted to mute and music playing is not restored to the original volume until the music volume headset completes the headset fitness detection, a problem of intermittent music playing is caused, and user experience is affected. If the music volume is lowered and music playing is not restored to the original volume until the music volume headset completes the headset fitness detection, a problem of fluctuating music volume is caused, and user experience is also affected.

In the headset fitness detection method provided in this embodiment of this application, the headset processes a mutually exclusive scenario for the headset fitness detection, to reduce a priority of the headset fitness detection. When the headset detects that an ongoing service and the headset fitness detection are mutually exclusive, the headset prohibits the headset fitness detection, or when the headset needs to perform, while performing the headset fitness detection, a service that is mutually exclusive to the headset fitness detection, the headset interrupts the headset fitness detection. Because the headset processes the mutually exclusive scenario for the headset fitness detection, and does not rely on permissions granted by an operating system to the headset application, the headset may be compatible with a plurality of operating systems, so that compatibility of a headset fitness detection function is improved. In addition, because a service that is currently being processed and that is mutually exclusive to the headset fitness detection is not interrupted or affected, user experience is not affected.

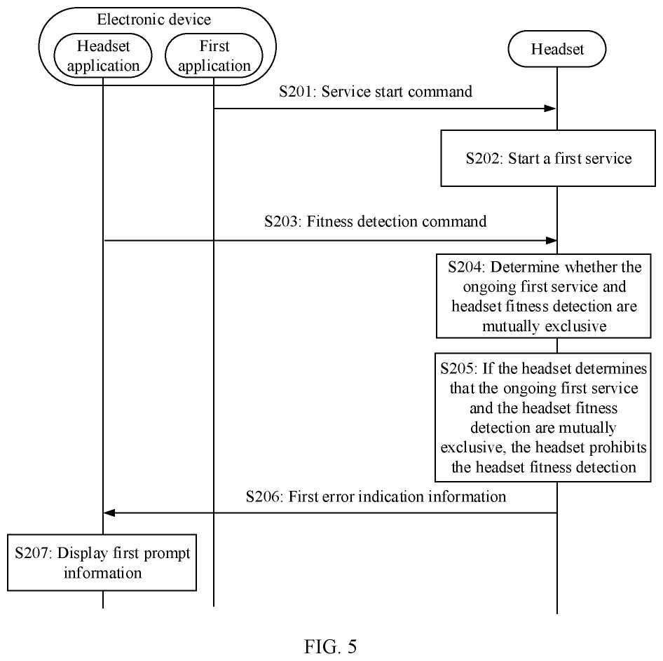

For the first type of scenario shown in FIG. 4, that is, the headset is already performing the first service (for the first service, refer to the descriptions in step S201), and then the electronic device indicates the headset to perform the headset fitness detection, if the headset determines that the ongoing first service and the headset fitness detection are mutually exclusive, the headset prohibits the headset fitness detection (that is, does not start the headset fitness detection), and sends first error indication information to the electronic device, to indicate that the headset prohibits the headset fitness detection. Specifically, as shown in FIG. 5, the headset fitness detection method includes:

S201: An electronic device sends a service start command to a headset.

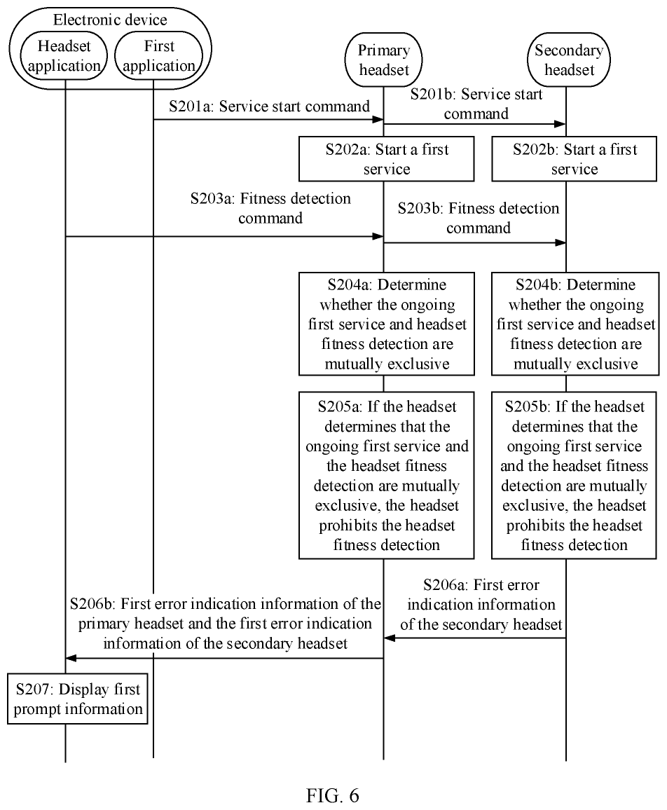

A first application on the electronic device sends the service start command to the headset. Correspondingly, the headset receives the service start command from the first application on the electronic device. In a dual-ear mode, the first application on the electronic device may separately send the service start command to a primary headset and a secondary headset, that is, the headset in FIG. 5 may be the primary headset or the secondary headset. Alternatively, as shown in S201a and S201b in FIG. 6, in the dual-ear mode, the first application on the electronic device sends the service start command to the primary headset, and the primary headset forwards the received service start command to the secondary headset.

The first application is an application other than a headset application, such as a music player, telephone software, a voice assistant, or video software. The headset application is an application that is used in combination with the headset, and may implement configuration for the headset (for example, configuring a headset fitness detection parameter (such as a noise reduction parameter) or performing headset fitness detection), and perform online upgrade on the headset.

The service start command is used to indicate the headset to start a first service, and the first service is a service in which the noise reduction parameter of the headset is changed, or a service in which another piece of audio other than audio required by the headset fitness detection is played. The audio required by the headset fitness detection is the foregoing preset audio, and the preset audio is pre-stored in the headset when the headset is delivered from factory.

As described above, the service in which the noise reduction parameter of the headset may include at least one of the following services: a voice assistant wake-up service, a call service, and the like. The electronic device transmits audio data of these services to the headset through a voice transmission channel. For example, the voice transmission channel may be an SCO channel. In these services, voice needs to be collected, and noise needs to be reduced. Therefore, the noise reduction parameter of the headset is changed. Based on the principle of the headset fitness detection described above, during the headset fitness detection, the headset plays the preset audio based on a preset headset fitness detection parameter (for example, the noise reduction parameter). Consequently: accuracy of the headset fitness detection is reduced in these services.

The service in which another piece of audio other than the audio required by the headset fitness detection is played may include at least one of the following services: a media playing service (for example, playing music) and a long prompt tone playing service (for example, playing an incoming call prompt tone, an outgoing call prompt tone. TTS audio, or self-defined audio). The electronic device transmits audio data of these services to the headset through an audio transmission channel. For example, the audio transmission channel may be an A2DP channel. In these services, audio other than the preset audio is played. Based on the principle of the headset fitness detection described above, during the headset fitness detection, the headset plays the preset audio based on the preset headset fitness detection parameter (for example, the noise reduction parameter). Therefore, audio played in these services is mixed with the preset audio. Consequently, accuracy of the headset fitness detection is reduced.

Specifically; the service start command may be a status switching command for the voice transmission channel (for example, an SCO channel), and the status switching command for the voice transmission channel (for example, an SCO channel) indicates the headset to switch the voice transmission channel (for example, an SCO channel) from an idle state to a connected state, to indicate the headset to start the first service (for example, the voice assistant wake-up service or the call service). The voice transmission channel is occupied in the connected state, and is not occupied in the idle state. Alternatively, the service start command may be a status switching command for the audio transmission channel (for example, an A2DP channel), and the status switching command for the audio transmission channel (for example, an A2DP channel) indicates the headset to switch the audio transmission channel (for example, an A2DP channel) from an idle state to a playing state or a paused state, to indicate the headset to start the first service (for example, the media playing service and the long prompt tone playing service). The audio transmission channel of the headset stops playing audio in the idle state, plays audio in the playing state, and pauses audio playing in the paused state. The audio transmission channel is occupied in the playing state or the paused state, and is not occupied in the idle state.

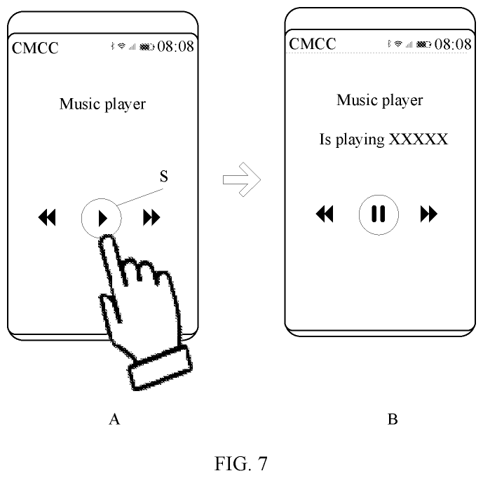

For example, the electronic device is a mobile phone. A trigger condition for sending the service start command to the headset by the electronic device includes but is not limited to: For example, as shown in A in FIG. 7, if a user taps a music play button S in a music player (that is, the first application described above), the music player is triggered to play music by using the headset (that is, the media playing service is triggered): the user triggers, by using a temperature measurement application on the electronic device, the headset to play temperature measurement TTS audio (that is, the long prompt tone playing service is triggered): if the user taps a dial button to make a call, the headset is triggered to play an outgoing call prompt tone (that is, the long prompt tone playing service is triggered): if the electronic device is called, the headset is triggered to play an incoming call prompt tone (that is, the long prompt tone playing service is triggered): if the user taps an answer button to answer a call, the headset is triggered to transmit voice (that is, the call service is triggered): if the user utters a keyword to the electronic device to wake up a voice assistant, the headset is triggered to transmit audio related to the voice assistant to the electronic device (that is, the voice assistant wake-up service is triggered); and so on.

S202: The headset starts the first service.

As shown in S202a and S202b in FIG. 6, in the dual-ear mode, the primary headset and the secondary headset separately start the first service. Specifically; the primary headset and the secondary headset transfer service start commands received by Bluetooth driver layers to respective application layers, and the application layers start the first service. The Bluetooth driver layer of the headset is configured to implement Bluetooth communication between the headset and the electronic device, for example, a transmission command, audio data, or voice data. The application layer is configured to start the first service, perform the headset fitness detection, and the like.

It is assumed that the service start command is a status switching command for the voice transmission channel (for example, an SCO channel), and the status switching command for the voice transmission channel (for example, an SCO channel) indicates the headset to switch the voice transmission channel (for example, an SCO channel) from an idle state to a connected state. In this case, the application layer of the headset switches the voice transmission channel (for example, an SCO channel) from the idle state to the connected state, and starts the first service. For example, to start the voice assistant wake-up service or the call service, a loudspeaker in the headset plays audio from the electronic device, and sends ambient sound collected by a microphone to the electronic device.

Alternatively, it is assumed that the service start command is a status switching command for the audio transmission channel (for example, an A2DP channel), and the status switching command for the audio transmission channel (for example, an A2DP channel) indicates the headset to switch the audio transmission channel (for example, an A2DP channel) from an idle state to a playing state or a paused state. In this case, the application layer of the headset switches the audio transmission channel (for example, an A2DP channel) from the idle state to the playing state or the paused state, and starts the first service. For example, to start the media playing service or the long prompt tone playing service, a loudspeaker in the headset plays audio from the electronic device.

After starting the first service, the headset may send start indication information to the first application on the electronic device, to indicate that the first service is started. In this case, the first application may display prompt information, to indicate, to the user, that the headset is currently running the first service. For example, as shown in B in FIG. 7, the music player on the electronic device may display an interface “Is playing XXXXX”, to prompt the user that music is being played by using the headset.

S203: The electronic device sends a fitness detection command to the headset.

The headset application on the electronic device sends the fitness detection command to the headset. Correspondingly, the headset receives the fitness detection command from the headset application on the electronic device. In the dual-ear mode, the headset application on the electronic device may separately send the fitness detection command to the primary headset and the secondary headset, that is, the headset in FIG. 5 may be the primary headset or the secondary headset. Alternatively, as shown in S203a and S203b in FIG. 6, in the dual-ear mode, the headset application on the electronic device sends the fitness detection command to the primary headset, and the primary headset forwards the received fitness detection command to the secondary headset. The fitness detection command is used to indicate the headset to perform the headset fitness detection.

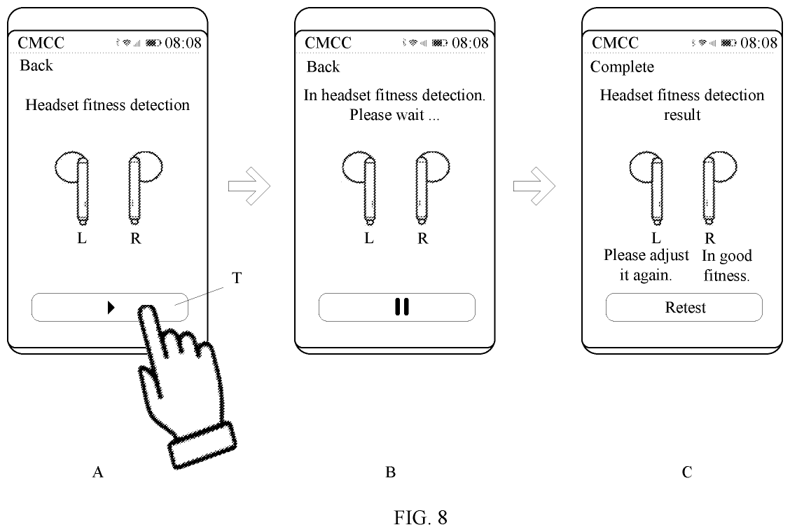

For example, as shown in A in FIG. 8, the electronic device is a mobile phone. A trigger condition for sending the fitness detection command to the headset by the electronic device may include but is not limited to: The headset application on the electronic device displays a “headset fitness detection” interface, and the user taps a headset fitness detection button T. As shown in B in FIG. 8, in a non-mutually exclusive scenario, in a process in which the headset performs the headset fitness detection, the headset application on the electronic device displays “In headset fitness detection. Please wait . . . ”. If the user taps the headset fitness detection button T in this case, the headset fitness detection may be stopped. After completing the headset fitness detection, the headset may send a detection result to the headset application on the electronic device, to indicate completion of the headset fitness detection and fitness of each headset. In this case, the headset application may display prompt information, to indicate, to the user, the completion of the headset fitness detection and the fitness of each headset. For example, as shown in C in FIG. 8, after the headset completes the headset fitness detection, if a specific headset is in good fitness, the headset application on the electronic device may display “good fitness” (for example, a right headset R in FIG. 8); or if a specific headset is in poor fitness, the headset application on the electronic device may display “Please adjust” (for example, a left headset L in FIG. 8). After the user adjusts the headset, the user may tap the headset fitness detection button T to perform the headset fitness detection again.

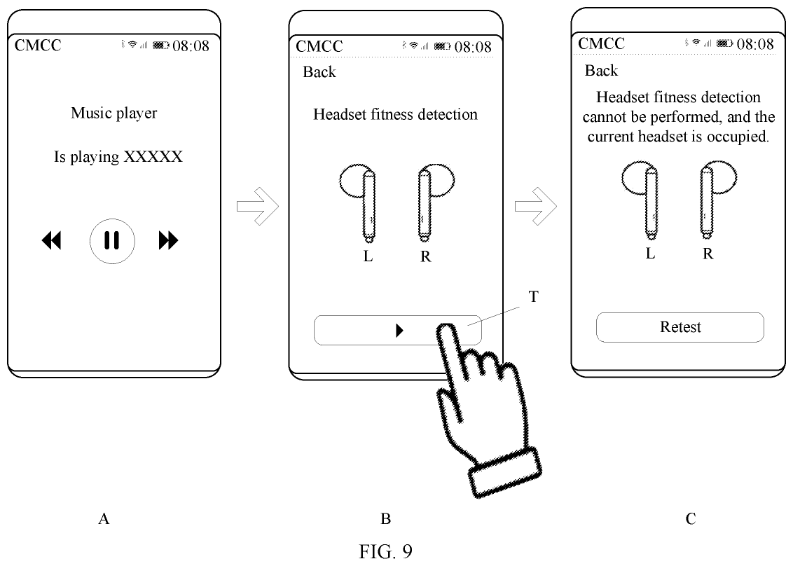

For example, as shown in A in FIG. 9, in a mutually exclusive scenario, it is assumed that the music player on the electronic device is playing music by using the headset. In this case, as shown in B in FIG. 9, the user switches to the headset application, and the user taps the headset fitness detection button T, and the electronic device sends the fitness detection command to the headset.

S204: The headset determines whether the ongoing first service and the headset fitness detection are mutually exclusive.

In other words, the headset determines whether a service that is mutually exclusive to the headset fitness detection is being performed. As shown in S204a and S204b in FIG. 6, in the dual-ear mode, both the primary headset and the secondary headset need to determine whether the first service that is being performed by the primary headset and the secondary headset is mutually exclusive to the headset fitness detection. Specifically, the primary headset and the secondary headset transfer fitness detection commands received by the Bluetooth driver layers to the respective application layers, and the application layers determine whether the ongoing first service and the headset fitness detection are mutually exclusive.

The application layer of the headset may determine, by determining that the voice transmission channel (for example, an SCO channel) of the headset is in the connected state, that the ongoing first service (for example, the voice assistant wake-up service or the call service) and the headset fitness detection are mutually exclusive. Alternatively, the application layer of the headset may determine, by determining that the audio transmission channel (for example, an A2DP channel) of the headset is in the playing state or the paused state, that the ongoing first service (for example, the media playing service or the long prompt tone playing service) and the headset fitness detection are mutually exclusive.

When the voice transmission channel of the headset is in the connected state, it indicates that the electronic device is transmitting audio data of the call service or the voice assistant wake-up service to the headset through the voice transmission channel of the headset. When the audio transmission channel of the headset is in the playing state or the paused state, it indicates that the electronic device is transmitting audio data of the media playing service or the long prompt tone playing service to the headset through the audio transmission channel of the headset.

The application layer of the headset may determine, by determining that the voice transmission channel (for example, an SCO channel) of the headset is in a disconnected state, and that the audio transmission channel (for example, an A2DP channel) of the headset is in an idle state, that the ongoing first service and the headset fitness detection are not mutually exclusive.

S205: If the headset determines that the ongoing first service and the headset fitness detection are mutually exclusive, the headset prohibits the headset fitness detection.

As shown in S205a and S205b in FIG. 6, in the dual-ear mode, both the primary headset and the secondary headset need to prohibit the primary headset and the secondary headset from performing the headset fitness detection. In this case, the headset does not play the preset audio through the loudspeaker, does not capture sound through the microphone, and does not perform the headset fitness detection by using a processor.

S206: The headset sends first error indication information to the electronic device.

The headset sends the first error indication information to the headset application on the electronic device. Correspondingly, the headset application on the electronic device receives the first error indication information from the headset. In the dual-ear mode, the primary headset and the secondary headset may separately send respective first error indication information to the electronic device, that is, the headset in FIG. 5 may be the primary headset or the secondary headset. Alternatively, as shown in S206a and S206b in FIG. 6, in the dual-ear mode, the secondary headset sends first error indication information of the secondary headset to the electronic device by using the primary headset. To be specific, the secondary headset sends the first error indication information of the secondary headset to the primary headset, and the primary headset sends first error indication information of the primary headset and the first error indication information of the secondary headset to the headset application on the electronic device. The first error indication information of the primary headset and the first error indication information of the secondary headset may be in a same message or in different messages.

The first error indication information is used to indicate that the headset is prohibited from performing the headset fitness detection, the first error indication information of the primary headset is used to indicate that the primary headset is prohibited from performing the headset fitness detection, and the first error indication information of the secondary headset is used to indicate that the secondary headset is prohibited from performing the headset fitness detection. The first error indication information may be in an error code form, and error code used for the first error indication information of the primary headset is different from error code used for the first error indication information of the secondary headset. For example, a binary number 00 may be used to represent the first error indication information of the primary headset, and a binary number 01 may be used to represent the first error indication information of the secondary headset.

S207: The electronic device displays first prompt information.

After receiving the first error indication information from the headset, the electronic device may display the first prompt information on a display screen. In the dual-ear mode, the electronic device may display the first prompt information on the display screen provided that at least one of the first error indication information of the primary headset or the first error indication information of the secondary headset is received. The first prompt information is used to prompt the user that the headset fitness detection can be started only when the ongoing first service that is mutually exclusive to the headset fitness detection is stopped. For example, as shown in C in FIG. 9), the headset application on the electronic device may display “Headset fitness detection cannot be performed, and the current headset is occupied”, to prompt the user that if the headset fitness detection needs to be performed, the ongoing first service that is mutually exclusive to the headset fitness detection needs to be stopped, to avoid reducing accuracy of the headset fitness detection.

According to the foregoing headset fitness detection method provided in this embodiment of this application, the headset is already performing the first service, and in the first service, a service of the noise reduction parameter of the headset may be changed, or another piece of audio other than the audio required for the headset fitness detection may be played. Consequently, accuracy of the headset fitness detection is reduced. In this case, if the headset receives the fitness detection command (the fitness detection command is used to indicate the headset to perform the headset fitness detection), the headset prohibits the headset fitness detection (that is, does not start the headset fitness detection). Therefore, the headset performs control logic to avoid a conflict with the first service by reducing a priority of the headset fitness detection, and does not rely on permissions granted to the headset application by an operating system in the electronic device. For electronic devices using different operating systems, the headset has consistent processing for a mutually exclusive scenario, and therefore compatibility of the headset fitness detection can be improved. Optionally, the headset may further send the first error indication information to the electronic device, to indicate the headset to prohibit the headset fitness detection, so that it is convenient for the electronic device to remind the user.

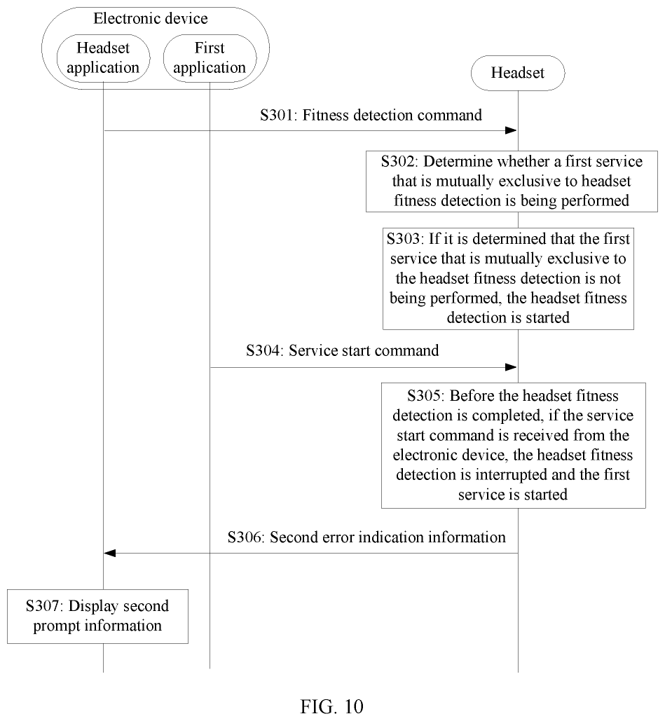

For the second type of scenario shown in FIG. 4, that is, the headset is already performing the headset fitness detection, and then the electronic device indicates the headset to perform the first service that is mutually exclusive to the headset fitness detection, the headset interrupts the headset fitness detection, and sends second error indication information to the electronic device, to indicate to interrupt the headset fitness detection. Specifically, as shown in FIG. 10, the headset fitness detection method includes:

S301: An electronic device sends a fitness detection command to a headset.

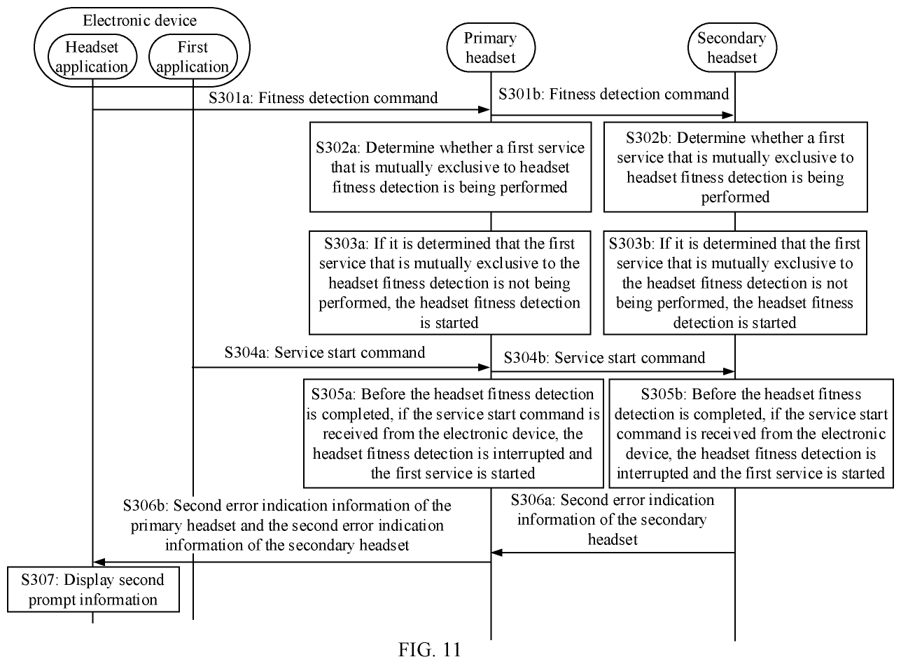

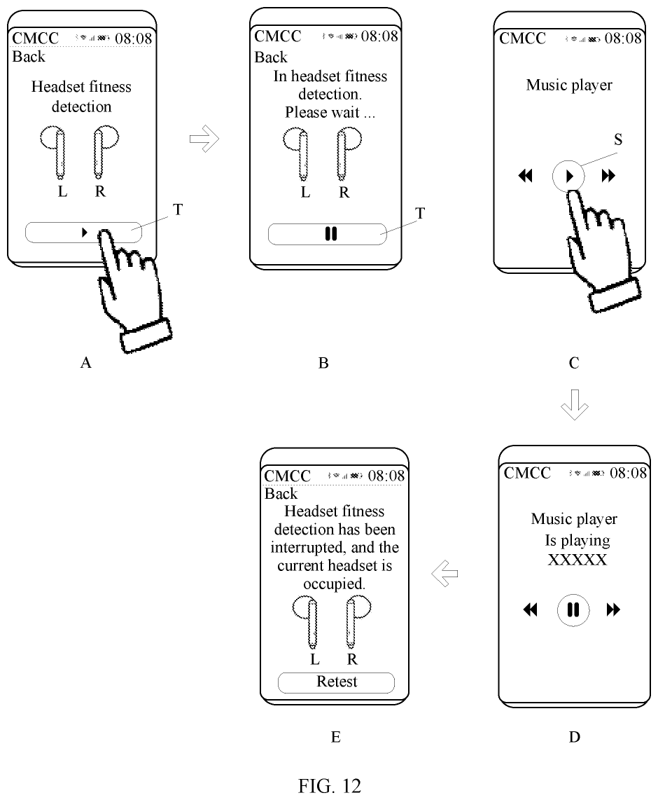

A headset application on the electronic device sends the fitness detection command to the headset. Correspondingly, the headset receives the fitness detection command from the headset application on the electronic device. In a dual-ear mode, the headset application on the electronic device may separately send the fitness detection command to a primary headset and a secondary headset, that is, the headset in FIG. 10 may be the primary headset or the secondary headset. Alternatively, as shown in S301a and S301b in FIG. 11, in the dual-ear mode, the headset application on the electronic device sends the fitness detection command to the primary headset, and the primary headset forwards the received fitness detection command to the secondary headset.

As shown in A in FIG. 12, the headset application on the electronic device displays a “headset fitness detection” interface, a user taps a headset fitness detection button T. and the headset application on the electronic device sends the fitness detection command to the headset.

For other content of step S301, refer to step S203. Repeated descriptions are not provided herein.

S302: The headset determines whether a first service that is mutually exclusive to headset fitness detection is being performed.

As shown in S302a and S302b in FIG. 11, in the dual-ear mode, both the primary headset and the secondary headset need to determine whether the primary headset and the secondary headset are performing the first service that is mutually exclusive to the headset fitness detection. Specifically; the primary headset and the secondary headset transfer fitness detection commands received by Bluetooth driver layers to respective application layers, and the application layers determine whether the first service that is mutually exclusive to the headset fitness detection is being performed.

For the first service, refer to step S201. Details are not described herein again.

The application layer of the headset may determine, by determining that a voice transmission channel (for example, an SCO channel) of the headset is in a connected state, that the first service (for example, a voice assistant wake-up service or a call service) that is mutually exclusive to the headset fitness detection is being performed. Alternatively, the application layer of the headset may determine, by determining that an audio transmission channel (for example, an A2DP channel) of the headset is in a playing state or a paused state, that the first service (for example, a media playing service or a long prompt tone playing service) that is mutually exclusive to the headset fitness detection is being performed.

When the voice transmission channel of the headset is in the connected state, it indicates that the electronic device is transmitting audio data of the call service or the voice assistant wake-up service to the headset through the voice transmission channel of the headset. When the audio transmission channel of the headset is in the playing state or the paused state, it indicates that the electronic device is transmitting audio data of the media playing service or the long prompt tone playing service to the headset through the audio transmission channel of the headset. Accuracy of the headset fitness detection is reduced.

The application layer of the headset may determine, by determining that the voice transmission channel (for example, an SCO channel) of the headset is in a disconnected state, and that the audio transmission channel (for example, an A2DP channel) of the headset is in an idle state, that the headset is not performing the first service that is mutually exclusive to the headset fitness detection.

When the voice transmission channel of the headset is in the disconnected state, it indicates that the electronic device is not transmitting audio data of the call service or the voice assistant wake-up service to the headset through the voice transmission channel of the headset. When the audio transmission channel of the headset is in the idle state, it indicates that the electronic device is not transmitting audio data of the media playing service or the long prompt tone playing service to the headset through the audio transmission channel of the headset. Therefore, accuracy of the headset fitness detection is not reduced.

S303: If the headset determines that the first service that is mutually exclusive to the headset fitness detection is not being performed, the headset starts the headset fitness detection. As shown in S303a and S303b in FIG. 11, in the dual-ear mode, both the primary

headset and the secondary headset need to determine that the primary headset and the secondary headset are not performing the first service that is mutually exclusive to the headset fitness detection, and start the headset fitness detection.

As described above, in a process of the headset fitness detection, a loudspeaker in the headset plays a preset audio segment based on a preset headset fitness detection parameter (for example, a noise reduction parameter), a microphone (located outside an ear canal) in the headset captures ambient sound (including preset audio leaked from a gap between the ear canal and the headset), and the headset determines a leakage value of the preset audio by analyzing the played preset audio and the received leaked preset audio. A smaller leakage value indicates a higher degree of fitness between the ear canal of the user and the headset.

For example, as shown in B in FIG. 12, in a process in which the headset performs the headset fitness detection, the headset application on the electronic device displays “In headset fitness detection. Please wait . . . ”. If the user taps the headset fitness detection button T in this case, the headset fitness detection may be stopped.

S304: The electronic device sends a service start command to the headset.

A first application on the electronic device sends the service start command to the headset. Correspondingly, the headset receives the service start command from the electronic device. In the dual-ear mode, the first application on the electronic device may separately send the service start command to the primary headset and the secondary headset, that is, the headset in FIG. 10 may be the primary headset or the secondary headset. Alternatively, as shown in S304a and S304b in FIG. 11, in the dual-ear mode, the first application on the electronic device sends the service start command to the primary headset, and the primary headset forwards the received service start command to the secondary headset.

The service start command is used to indicate the headset to start the first service. The service start command may be a status switching command for the voice transmission channel (for example, an SCO channel), and the status switching command for the voice transmission channel (for example, an SCO channel) indicates the headset to switch the voice transmission channel (for example, an SCO channel) from an idle state to a connected state, to indicate the headset to start the first service (for example, the voice assistant wake-up service or the call service). Alternatively, the service start command may be a status switching command for the audio transmission channel (for example, an A2DP channel), and the status switching command for the audio transmission channel (for example, an A2DP channel) indicates the headset to switch the audio transmission channel (for example, an A2DP channel) from an idle state to a playing state or a paused state, to indicate the headset to start the first service (for example, the media playing service and the long prompt tone playing service).

For example, as shown in B and C in FIG. 12, it is assumed that in a process in which the headset performs the headset fitness detection, the user switches to a music player (that is, the foregoing first application) and taps a play button S, and in this case, the music player sends the service start command to the headset, to indicate the headset to play music.

For other content of step S304, refer to step S201. Repeated descriptions are not provided herein.

S305: Before the headset fitness detection is completed, if the headset receives the service start command from the electronic device, the headset interrupts the headset fitness detection and starts the first service.

As shown in S305a and S305b in FIG. 11, in the dual-ear mode, the primary headset and the secondary headset respectively interrupt the headset fitness detection and start the first service that is mutually exclusive to the headset fitness detection. Specifically; the primary headset and the secondary headset transfer service start commands received by Bluetooth driver layers to respective application layers, and the application layers interrupt the headset fitness detection and start the first service that is mutually exclusive to the headset fitness detection.

That before the headset completes the headset fitness detection may mean: The headset is playing preset audio through the loudspeaker, playing the preset audio through the loudspeaker, and performing headset fitness detection by using a processor. That the headset interrupts the headset fitness detection may mean: The headset stops playing the preset audio through the loudspeaker, stops capturing sound through a microphone, and stops performing the headset fitness detection by using the processor.

After starting the first service, the headset may send start indication information to the first application on the electronic device, to indicate that the first service is started. In this case, the first application may display prompt information, to indicate, to the user, that the headset is currently running the first service. For example, as shown in D in FIG. 12, the music player on the electronic device may display an interface “Is playing XXXXX”, to prompt the user that music is being played by using the headset.

For other content of step S305, refer to step S202. Repeated descriptions are not provided herein.

S306: The headset sends second error indication information to the electronic device.

The headset sends the second error indication information to the headset application on the electronic device. Correspondingly, the headset application on the electronic device receives the second error indication information from the headset. In the dual-ear mode, the primary headset and the secondary headset may separately send respective second error indication information to the headset application on the electronic device, that is, the headset in FIG. 10 may be the primary headset or the secondary headset. Alternatively, as shown in S306a and S306b in FIG. 11, in the dual-ear mode, the secondary headset sends second error indication information of the secondary headset to the electronic device by using the primary headset. To be specific, the secondary headset sends the second error indication information of the secondary headset to the primary headset, and the primary headset sends second error indication information of the primary headset and the second error indication information of the secondary headset to the headset application on the electronic device. The second error indication information of the primary headset and the second error indication information of the secondary headset may be in a same message or in different messages.

The second error indication information is used to indicate the headset to interrupt the headset fitness detection, the second error indication information of the primary headset is used to indicate the primary headset to interrupt the headset fitness detection, and the second error indication information of the secondary headset is used to indicate the secondary headset to interrupt the headset fitness detection. The second error indication information may be in an error code form, and error code used for the second error indication information of the primary headset is different from error code used for the second error indication information of the secondary headset. For example, a binary number 10 may be used to represent the second error indication information of the primary headset, and a binary number 11 may be used to represent the second error indication information of the secondary headset.

S307: The electronic device displays second prompt information.

After receiving the second error indication information from the headset, the electronic device may display the second prompt information on a display screen. In the dual-ear mode, the electronic device may display the second prompt information on the display screen provided that at least one of the second error indication information of the primary headset or the second error indication information of the secondary headset is received. The second prompt information is used to prompt the user that the headset has interrupted the headset fitness detection. For example, as shown in E in FIG. 12, if the user switches back from the music player to the headset application, the headset application on the electronic device may display “Headset fitness detection has been interrupted. The current headset is occupied”, to prompt the user that the headset has interrupted the headset fitness detection due to the ongoing first service.

According to the foregoing headset fitness detection method provided in this embodiment of this application, when the headset is already performing the headset fitness detection, if a command indicating the headset to perform the first service that is mutually exclusive to the headset fitness detection is received, the headset interrupts the headset fitness detection. In the first service that is mutually exclusive to the headset fitness detection, the noise reduction parameter of the headset may be changed, or another piece of audio other than the audio required for the headset fitness detection may be played. Consequently, accuracy of the headset fitness detection is reduced. Therefore, the headset performs control logic to avoid a conflict with the first service by reducing a priority of the headset fitness detection, and does not rely on permissions granted to the headset application by an operating system in the electronic device. For electronic devices using different operating systems, the headset has consistent processing for a mutually exclusive scenario, and therefore compatibility of the headset fitness detection can be improved. Optionally, the headset may further send the second error indication information to the electronic device, to indicate that the headset has interrupted the headset fitness detection, so that it is convenient for the electronic device to remind the user.

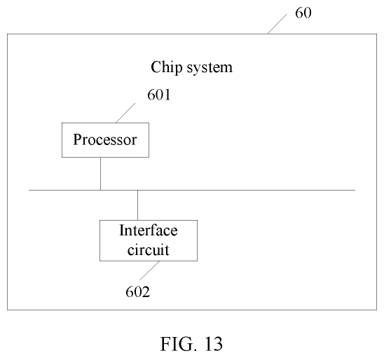

As shown in FIG. 13, an embodiment of this application further provides a chip system. The chip system 60 includes at least one processor 601 and at least one interface circuit 602. The at least one processor 601 and the at least one interface circuit 602 may be interconnected through a line. The processor 601 is configured to support a headset in implementing various steps in the foregoing method embodiments, such as the methods shown in FIG. 5, FIG. 6, FIG. 10, and FIG. 11. The at least one interface circuit 602 may be configured to receive a signal from another apparatus (such as a memory), or transmit a signal to another apparatus (such as a communication interface). The chip system may include a chip, or may include another discrete component.

An embodiment of this application further provides a computer-readable storage medium, and the computer-readable storage medium includes instructions. When the instructions are run on a headset, the headset is enabled to perform various steps in the foregoing method embodiments, such as the methods shown in FIG. 5, FIG. 6, FIG. 10, and FIG. 11.

An embodiment of this application further provides a computer program product including instructions. When the instructions are run on a headset, the headset is enabled to perform various steps in the foregoing method embodiments, such as the methods shown in FIG. 5, FIG. 6, FIG. 10, and FIG. 11.

For technical effects of the chip system, the computer-readable storage medium, and the computer program product, reference may be made to the technical effects of the foregoing method embodiments.

It should be understood that in various embodiments of this application, sequence numbers of the foregoing processes do not mean a sequence of execution. The execution sequence of the processes should be determined based on functions and internal logic of the processes, and should not constitute any limitation on an implementation process of embodiments of this application.

A person of ordinary skill in the art may be aware that the example modules and algorithm steps described with reference to the embodiments disclosed in this specification can be implemented by using electronic hardware or a combination of computer software and electronic hardware. Whether these functions are performed by hardware or software depends on specific applications and design constraints of the technical solutions. A person skilled in the art may use different methods to implement the described functions for each specific application, but it should not be considered that such an implementation goes beyond the scope of this application.

A person skilled in the art may clearly understand that for ease and brevity of description, for a specific operation process of the system, apparatus, and module described above, refer to a corresponding process in the foregoing method embodiments. Details are not described herein.

In the several embodiments provided in this application, it should be understood that the disclosed system, device, and method may be implemented in another manner. For example, the described device embodiment is merely an example. For example, division of the modules is merely logical function division and there may be other division manners during actual implementation. For example, a plurality of modules or components may be combined or integrated into another device, or some features may be ignored or not performed. In addition, the displayed or discussed mutual couplings or direct couplings or communication connections may be implemented by using some interfaces. The indirect couplings or communication connections between the devices or modules may be implemented in electronic, mechanical, or other forms.

The modules described as separate components may or may not be physically separate, and components displayed as modules may or may not be physical modules, may be located in one device, or may be distributed on a plurality of devices. Some or all of the modules may be selected based on an actual requirement, to achieve the objectives of the solutions in the embodiments.

In addition, functional modules in embodiments of this application may be integrated into one device, or each of the modules may exist alone physically, or two or more modules may be integrated into one device.

All or some of the foregoing embodiments may be implemented by using software, hardware, firmware, or any combination thereof. When being implemented by using a software program, all or some of the foregoing embodiments may be implemented in a form of a computer program product. The computer program product includes one or more computer instructions. When the computer program instructions are loaded and executed on a computer, all or some of the procedures or functions in embodiments of this application are generated. The computer may be a general-purpose computer, a dedicated computer, a computer network, or another programmable apparatus. The computer instructions may be stored in a computer-readable storage medium or transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) manner or a wireless (for example, infrared, radio, or microwave) manner. The computer-readable storage medium may be any usable medium accessible by a computer, or a data storage device, for example, a server or a data center, integrating one or more usable media. The available medium may be a magnetic medium (for example, a floppy disk, a hard disk, or a magnetic tape), an optical medium (for example, a DVD), or a semiconductor medium (for example, a solid state disk (solid state disk, SSD)), or the like.

The foregoing descriptions are merely specific implementations of this application, but are not intended to limit the protection scope of this application. Any person skilled in the art can readily figure out variations or replacements within the technical scope disclosed in this application, and these variations or replacements shall fall within the protection scope of this application. Therefore, the protection scope of this application shall be subject to the protection scope of the claims.

1. A method, comprising:
receiving a service start command from an electronic device, wherein the service start command indicates to a headset to start a first service, and wherein the first service is a service in which a noise reduction parameter of the headset is changed, or a service in which a piece of audio other than audio required for headset fitness detection is played;
starting the first service;
receiving a fitness detection command from the electronic device, wherein the fitness detection command indicates to the headset to perform the headset fitness detection; and
prohibiting the headset fitness detection if the started first service and the headset fitness detection are mutually exclusive.

2. The method of claim 1, wherein the first service comprises at least one of the following services: a media playing service, a call service, a long prompt tone playing service, or a voice assistant wake-up service.

3. The method of claim 2, wherein the first service is a call service or a voice assistant wake-up service, and the started first service and the headset fitness detection are mutually exclusive if a voice transmission channel of the headset is in a connected state.

4. The method of claim 3, wherein the voice transmission channel is a synchronous connection oriented channel.

5. The method of claim 2, wherein the first service is a media playing service or a long prompt tone playing service, and the started first service and the headset fitness detection are mutually exclusive if an audio transmission channel of the headset is in a playing state or a paused state.

6. The method of claim 5, wherein the audio transmission channel is an advanced audio distribution profile (A2DP) channel.

7. The method of claim 1, further comprising sending first error indication information to the electronic device based on the started first service and the headset fitness detection being mutually exclusive, wherein the first error indication information indicates that the headset prohibits the headset fitness detection.

8. A method, comprising:
receiving a fitness detection command from an electronic device, wherein the fitness detection command indicates to a headset to perform headset fitness detection; and
starting the headset fitness detection if a first service that is mutually exclusive to the headset fitness detection is not being performed, wherein the first service is a service in which a noise reduction parameter of the headset is changed, or a service in which a piece of audio other than audio required for the headset fitness detection is played,
wherein before the headset fitness detection is completed, if a service start command is received from the electronic device, the method further comprises interrupting the headset fitness detection, and starting the first service, wherein the service start command indicates to the headset to start the first service.

9. The method of claim 8, wherein the first service comprises at least one of the following services: a media playing service, a call service, a long prompt tone playing service, or a voice assistant wake-up service.

10. The method of claim 9, wherein the first service is a call service or a voice assistant wake-up service, and the first service that is mutually exclusive to the headset fitness detection is not being performed if a voice transmission channel of the headset is in a disconnected state, and an audio transmission channel of the headset is in an idle state.

11. The method of claim 10, wherein the voice transmission channel is a synchronous connection oriented channel.

12. The method of claim 10, wherein the audio transmission channel is an advanced audio distribution profile (A2DP) channel.

13. The method of claim 10, wherein the first service is a media playing service or a long prompt tone playing service, and the service start command is a status switching command for the audio transmission channel, and wherein the service start command indicates to the headset to switch the audio transmission channel from the idle state to a playing state or a paused state.

14. The method of claim 10, wherein the first service is a call service or a voice assistant wake-up service, and the service start command is a status switching command for the voice transmission channel, and wherein the service start command indicates to the headset to switch the voice transmission channel from an idle state to a connected state.

15. The method of claim 8, wherein after receiving the service start command from the electronic device, the method further comprises sending second error indication information to the electronic device, wherein the second error indication information indicates that the headset interrupts the headset fitness detection.

16. A headset, comprising:
one or more processors; and
a memory coupled to the one or more processors and configured to store instructions that, when executed by the one or more processors, cause the headset to be configured to:
receive a fitness detection command from an electronic device, wherein the fitness detection command indicates to the headset to perform headset fitness detection; and
start the headset fitness detection if a first service that is mutually exclusive to the headset fitness detection is not being performed, wherein the first service is a service in which a noise reduction parameter of the headset is changed, or a service in which a piece of audio other than audio required for the headset fitness detection is played,
wherein before the headset fitness detection is completed, if a service start command is received from the electronic device, the headset is further configured to interrupt the headset fitness detection, and start the first service, wherein the service start command indicates to the headset to start the first service.

17. (canceled)

18. The headset of claim 16, wherein the first service comprises at least one of the following services: a media playing service, a call service, a long prompt tone playing service, or a voice assistant wake-up service.

19. The headset of claim 18, wherein the first service is a call service or a voice assistant wake-up service, and the first service that is mutually exclusive to the headset fitness detection is not being performed if a voice transmission channel of the headset is in a disconnected state, and an audio transmission channel of the headset is in an idle state.

20. The headset of claim 19, wherein the voice transmission channel is a synchronous connection oriented channel.

21. The headset of claim 19, wherein the audio transmission channel is an advanced audio distribution profile (A2DP) channel.
